(19) United States
(12) Patent Application Publication
(10) Pub. No.: US 2024/0351036 A1
(43) Pub. Date: Oct. 24, 2024

(54) MICROFLUIDIC PARTICLE SORTER

(71) Applicant: ADVANCED BIOMED INC., Tainan City (TW)

(72) Inventors: Chen-Yi LEE, Tainan City (TW); I-Fang CHENG, Tainan City (TW); Pei-Mei LU, Tainan City (TW); Chao-Hong CHEN, Tainan City (TW); Jyun-Hong WANG, Tainan City (TW); Meng-Yen TSAI, Tainan City (TW)

(21) Appl. No.: 18/633,201

(22) Filed: Apr. 11, 2024

Related U.S. Application Data
(60) Provisional application No. 63/496,086, filed on Apr. 14, 2023.

(30) Foreign Application Priority Data
Nov. 29, 2023 (TW) 112146335

(51) Int. Cl. B01L 3/00

(52) U.S. Cl. CPC B01L 3/502761; B01L 2200/0652; B01L 2200/16; B01L 2300/0681; B01L 2300/087

(57) ABSTRACT

A microfluidic particle sorter includes a chip body and at least one sorting unit provided inside the chip body and including a microfluidic channel and at least one first DLD array. The microfluidic channel extends along a length direction, has an inlet and an outlet, and has a first side and a second side. The at least one first DLD array includes first DLD columns arranged along the length direction. The first DLD columns, from the inlet toward the outlet, are gradually shifted toward the second side such that two adjacent ones of the first DLD columns are offset from each other by a predetermined distance. Each of the first DLD columns has first split pillars. Each of the first split pillars has a first upstream side and a first downstream side, and includes two first parts that are spaced apart from each other to define a first micro-gap.

### CROSS-REFERENCE TO RELATED APPLICATION

This application claims priority to U.S. Provisional Application No. 63/496,086 filed on Apr. 14, 2023, and Taiwanese Invention Patent Application No. 112146335, filed on Nov. 29, 2023, which are incorporated by reference herein in its entirety.

### FIELD

The disclosure relates to a particle sorter, and more particularly to a microfluidic particle sorter for sorting target particles and non-target particles in a sample fluid by deterministic lateral displacement (DLD).

### BACKGROUND

A common technique currently used for sorting circulating tumor cells (CTCs) in a sample fluid is the CTC enrichment/isolation method conducted using antibodies. In the CTC enrichment/isolation method, positive selection may be conducted using anti-EpCAM antibodies that are capable of binding to epithelial cell adhesion molecules (EpCAMs) on the CTCs, thereby capturing the CTCs. Although sorting by positive selection is efficient, such approach can result in a failure to capture some of the CTCs with low expression of antigens. The CTC enrichment/isolation method may also be conducted by negative selection, which uses anti-CD45/CD14 antibodies that are capable of specifically binding to CD45/CD14 cell surface markers on the non-target cells (e.g., white blood cells), thereby removing the non-target cells in the sample fluid. Although sorting by negative selection has high efficiency and high CTC recovery rate, use of the anti-CD45/CD14 antibodies would also remove certain cancer cells which express these cell surface markers, and removal of a large number of white blood cells requires a large number of antibodies, which is costly. Alternatively, the CTC enrichment/isolation method may be conducted by a filtration process utilizing a filter or a microporous device. Although the filtration process can be used to capture the CTCs, mutant cells and CTC clusters can also captured, resulting in such approach having a low purity. In addition, the viability of the CTCs thus captured is decreased because these cells were subjected to high shear stress during filtration. Furthermore, the CTC enrichment/isolation method may also be conducted by utilizing a microfluidic sorting chip, for example, a dielectrophoresis-based microfluidic chip, or sorting by deterministic lateral displacement (DLD), or other isolation processes. Even though sorting by the dielectrophoresis-based microfluidic chip results in a high purity of the thus obtained CTCs, the sample fluid has a low flow rate. Moreover, due to a requirement for a low ionic concentration, the sample fluid needs to be extensively diluted, resulting in the sample fluid having a large volume, and an increase in the time period for sorting. Although sorting by DLD also results in a high purity of the thus obtained CTCs, and the issue regarding ionic concentration does not have to be taken into consideration, such sorting technique cannot be used to separate some of the non-target cells (e.g., white blood cells) having particle sizes similar to those of the CTCs. Therefore, those skilled in the art strive to solve the problem faced in sorting CTCs by DLD.

### SUMMARY

Therefore, an object of the disclosure is to provide a microfluidic particle sorter that is for sorting target particles and non-target particles in a sample fluid by deterministic lateral displacement (DLD) and that can alleviate at least one of the drawbacks of the prior art.

According to the disclosure, the microfluidic particle sorter includes a chip body and at least one sorting unit which is provided inside the chip body. The at least one sorting unit includes a microfluidic channel and at least one first DLD array.

The microfluidic channel extends along a length direction. In addition, the microfluidic channel has an inlet and an outlet opposite to the inlet in the length direction, and has a first side and a second side opposite to the first side in a width direction.

The at least one first DLD array is disposed in the microfluidic channel and includes first DLD columns that are arranged along the length direction. The first DLD columns, from the inlet toward the outlet, are gradually shifted toward the second side such that two adjacent ones of the first DLD columns are offset from each other by a predetermined distance. Each of the first DLD columns has first split pillars that are disposed upright and spaced apart from one another along the width direction. Each of the first split pillars has a first upstream side that faces the inlet and a first downstream side that faces the outlet, and includes two first parts that are spaced apart from each other to define a first micro-gap which extends from the first upstream side to the first downstream side to allow the non-target particles, after deformation, to pass therethrough. The first micro-gap extends along a direction that forms a deflection angle with respect to the length direction so as to guide the non-target particles to move toward the first side. The deflection angle is not smaller than 1° and not greater than 89°. The first split pillars of the first DLD columns cooperately define first drainage channels in the microfluidic channel that are arranged along the width direction and interconnected with one another. Each of the first drainage channels extends from the inlet obliquely along the length direction toward the outlet and the second side.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a microfluidic particle sorter according to a first embodiment of the disclosure.

FIG. 2 is a partially cross-sectional view of the microfluidic particle sorter of FIG. 1.

FIG. 3 is a top view of a microfluidic channel inside the microfluidic particle sorter according to the first embodiment, illustrating arrangement of a plurality of first deterministic lateral displacement (DLD) arrays and a plurality of second DLD arrays.

FIG. 4 is a perspective view illustrating one of first split pillars in the microfluidic particle sorter according to the first embodiment of the disclosure.

FIG. 5 is an enlarged fragmentary view of the microfluidic channel of FIG. 3.

FIG. 6 is a perspective view illustrating one of second split pillars in the microfluidic particle sorter according to the first embodiment of the disclosure.

FIG. 7 is similar to FIG. 5, illustrating another implementation of the first split pillars and the second split pillars.

FIGS. 8 to 14 are top views illustrating other implementations of one of the first split pillars or one of the second split pillars.

FIGS. 15 to 17 are microscopic images showing different parts along a flow direction of a sample fluid when the microfluidic particle sorter according to the first embodiment of the disclosure performs sorting of circulating tumor cells (CTCs) and blood cells.

FIG. 18 is a microscopic image showing a number of blood cells in a target liquid after a sorter with a conventional DLD structure is subjected to a purity test using a blood-A549 sample fluid.

FIG. 19 is a microscopic image showing a number of blood cells in a target liquid after the microfluidic particle sorter according to the disclosure is subjected to a purity test using the blood-A549 sample fluid.

FIG. 20 is a top view of a microfluidic channel inside a microfluidic particle sorter according to a second embodiment of the disclosure, illustrating arrangement of a plurality of first DLD arrays.

FIG. 21 is a partially cross-sectional view illustrating microfluidic channels of two sorting units which are stacked on each other in a stacking direction in a microfluidic particle sorter according to a third embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

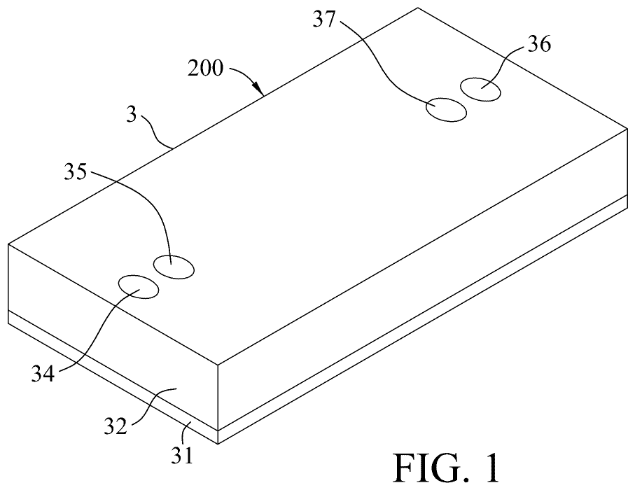

Referring to FIGS. 1 to 3, a first embodiment of a microfluidic particle sorter 200 according to the disclosure is suitable for sorting target particles 901 (not shown in FIGS. 1 to 3) and non-target particles 902 (not shown in FIGS. 1 to 3) in a sample fluid by deterministic lateral displacement (DLD). Examples of the sample fluid may include, but are not limited to, a blood sample, a pleural effusion sample, an ascites sample, a urine sample, and a diluted sample of a body fluid. Examples of the target particles 901 may include, but are not limited to, circulating tumor cells (CTCs) and tumor hybrid cells (THCs). The non-target particles 902 may be, for example, blood cells, such as white blood cells or red blood cells that have cellular deformation behavior. The target particles 901 and the non-target particles 902 satisfy an equation of the form: Dt>Ddnt, where Dt is a particle size of a smallest one of the target particles 901, and Ddnt is a narrow side width of a largest one of the non-target particles 902, after deformation.

The microfluidic particle sorter 200 includes a chip body 3 and at least one sorting unit which is provided inside the chip body 3 and includes at least one first DLD array 4. In the first embodiment, a single one sorting unit is provided inside the chip body 3, and includes a plurality of first DLD arrays 4 and a plurality of second DLD arrays 5.

It should be noted that since the plurality of first DLD arrays 4 and the plurality of second DLD arrays 5 are in the micro-sized range, the structure dimension of each component shown in the figures are only for illustration (not drawn to scale or proportion), and thus should not be construed as a limitation to implementation of the microfluidic particle sorter 200 of the disclosure.

The sorting unit provided inside the chip body 3 also includes a microfluidic channel 33. In addition, the chip body 3 includes a sample-fluid injection channel 34, a buffer injection channel 35, a waste-liquid outflow channel 36, and a target-particle collection channel 37.

In the first embodiment, the chip body 3 is a microfluidic chip manufactured by a microelectromechanical systems (MEMS) process, and includes a base 31 and a cover 32 that is stacked on the base 31 and formed with through holes and a bottom surface with indentations. The base 31, the indentations and the through holes of the cover 32 cooperately define the microfluidic channel 33, the sample-fluid injection channel 34, the buffer injection channel 35, the waste-liquid outflow channel 36, and the target-particle collection channel 37. Examples of materials for making each of the plate 31 and the cover 32 may include, but are not limited to, a polydimethylsiloxane (PDMS), a silicone elastomer, a crystalline silicon material, a glass, a poly(methyl methacrylate) (PMMA), a cyclic olefin copolymer (COC), and a polycarbonate (PC). Techniques for manufacturing the chip body 3 are within those skilled in the art, and types of materials for making the chip body 3 are numerous and should not be limited to the materials listed above, and details regarding the techniques and the types of materials are not further illustrated herein.

The microfluidic channel 33 extends along a length direction (L), and has an inlet 333 and an outlet 334 opposite to the inlet 333 in the length direction (L), i.e., the inlet 333 and the outlet 334 are spaced apart from each other in the length direction (L). In addition, the microfluidic channel 33 has a first side 331 and a second side 332 opposite to the first side 331 in a width direction (W), where the width direction (W) is horizontally orthogonal to the length direction (L). The microfluidic channel 33 also has two sorting areas 335 that are spaced apart in the width direction (W) and respectively located adjacent to the first side 311 and the second 332, and a collection area 336 that is located between the two sorting areas 335.

Both the sample-fluid injection channel 34 and the buffer injection channel 35 are fluidly connected to and are disposed upstream of the inlet 333, and each of them has an opening exposed from a top surface of the chip body 3. Moreover, the sample-fluid injection channel 34 includes two sample-fluid injection sections 341 that are respectively located upstream of the two sorting areas 335 so as to guide the sample fluid to flow into the two sorting areas 335. In other words, each of the two sample-fluid injection sections 341 has an upstream end and a downstream end. The upstream ends of the two sample-fluid injection sections 341 are connected to each other and located downstream of the opening of the sample-fluid injection channel 34. The downstream ends of the two sample-fluid injection sections 341 are respectively in fluid communication with and located upstream of the two sorting areas 335. The buffer injection channel 35 is located between the two sample-fluid injection sections 341 and upstream of the collection area 336 so as to guide a buffer liquid to flow into the collection area 336. That is to say, the buffer injection channel 35 is in fluid communication with the collection area 336.

Both the waste-liquid outflow channel 36 and the target-particle collection channel 37 are fluidly connected to the outlet 334 of the microfluidic channel 33, and each of them has an opening exposed from the top surface of the chip body 3. Moreover, the waste-liquid outflow channel 36 includes two waste-liquid outflow sections 361 that are respectively located downstream of the two sorting areas 335 so as to discharge a waste liquid from the two sorting areas 335. In other words, each of the two waste-liquid outflow sections 361 has a downstream end and an upstream end. The downstream ends of the two waste-liquid outflow sections 361 are connected to each other and located upstream of the opening of the waste-liquid outflow channel 36. The upstream ends of the two waste-liquid outflow sections 361 are respectively in fluid communication with and located downstream of the two sorting areas 335. The target-particle collection channel 37 is located between the two waste-liquid outflow sections 361 and downstream of the collection area 336 so as to collect a target liquid from the collection area 336. That is to say, the target-particle collection channel 37 is in fluid communication with the collection area 336, and is capable of discharging the target liquid out of the chip body 3.

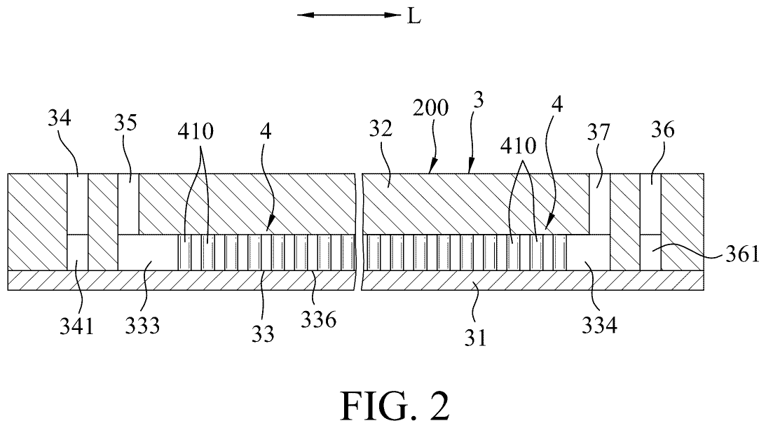

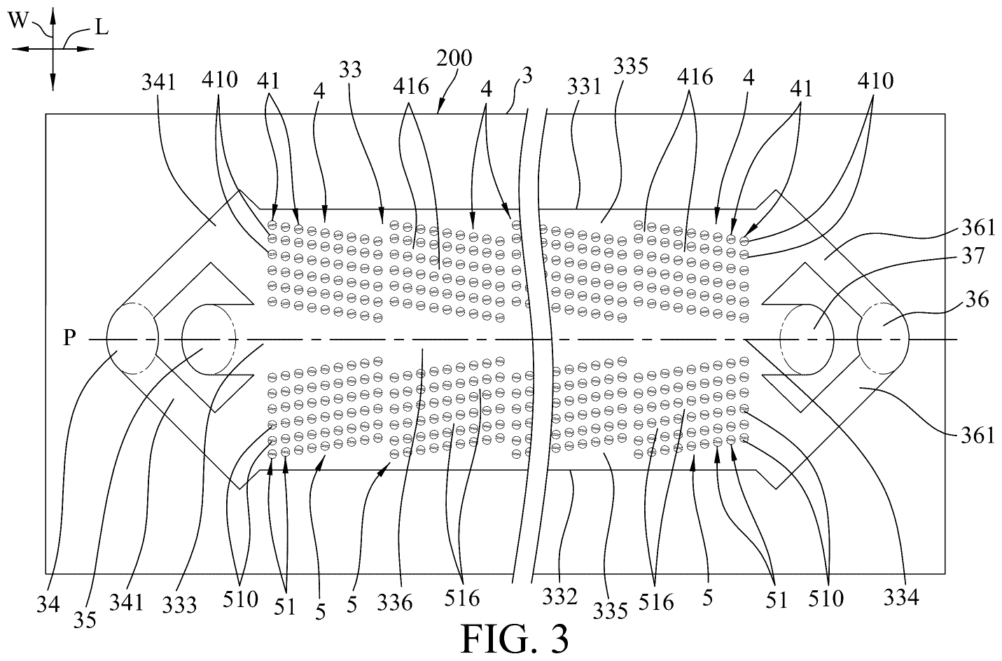

Referring to FIGS. 2 and 3, the plurality of first DLD arrays 4 and the plurality of second DLD arrays 5 are disposed between the plate 31 and the cover 32. In addition, the plurality of first DLD arrays 4 are mirror-symmetrical to the plurality of second DLD arrays 5 with respect to a plane (P) in the length direction (L). Specifically, the plurality of first DLD arrays 4 are located in one of the two sorting areas 335 that is adjacent to the first side 331, and the plurality of second DLD arrays 5 are located in the other one of the two sorting areas 335 that is adjacent to the second side 332. The plurality of first DLD arrays 4 are displaced from each other along the length direction (L) toward the outlet 334, and the plurality of second DLD arrays 5 are displaced from each other along the length direction (L) toward the outlet 334.

Because the plurality of first DLD arrays 4 are mirror-symmetrical to the plurality of second DLD arrays 5 with respect to the plane (P) in the length direction (L), for convenience of explanation, the following description only takes one of the plurality of first DLD arrays 4 for further illustration.

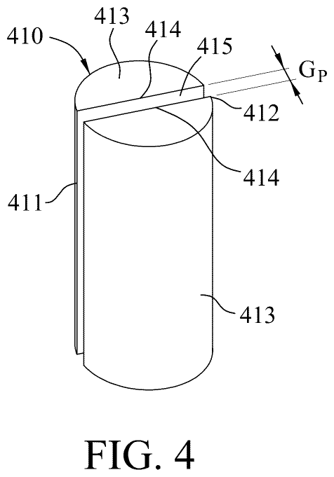

Referring to FIGS. 3 to 5, each of the plurality of first DLD arrays 4 includes first DLD columns 41 that are arranged in parallel at intervals along the length direction (L), and two adjacent ones of the first DLD columns 41 are spaced apart from each other in the length direction (L) by a first spacing (D1). Each of the first DLD columns 41 has first split pillars 410 that are disposed upright and spaced apart from one another along the width direction (W), and two adjacent ones of the first split pillars 410 are spaced apart from each other in the width direction (W) by a second spacing (D2) which is not smaller than the first spacing (D1) (i.e., D2≥D1). In addition, arrangement of the first split pillars 410 of the first DLD columns 41 further satisfies an equation of an equation of the form: 0.33<Dt/D2<1.2 where Dt and D2 are as described above. The foregoing equations indicate that the particle size (Dt) of the smallest one of the target particles 901 needs to be greater than 0.33 times the second spacing (D2) in order to perform DLD; however, the particle size (Dt) of the smallest one of the target particles 901 cannot be greater than 1.2 times the second spacing (D2), otherwise the target particles 901 will be blocked by the first split pillars 410. Additionally, a center-to-center distance of two adjacent ones of the first split pillars 410 of each of the first DLD columns 41 has a predetermined value (A).

The first DLD columns 41 of each of the plurality of first DLD arrays 4, from the inlet 333 toward the outlet 334, are gradually shifted toward the second side 332 such that two adjacent ones of the first DLD columns 41 are offset from each other by a predetermined distance (Δd). Moreover, the first split pillars 410 of a trailing one of the first DLD column 41 in one of the plurality of first DLD arrays 4 are respectively offset from the first split pillars 410 of a leading one of the first DLD column 41 in the one of the plurality of first DLD arrays 4 in the width direction (W) toward the second side 332 by the predetermined value (A), and based upon the foregoing description, the number of the first DLD columns 41 in each of the plurality of first DLD arrays 4 can be adjusted and set. In each of the first DLD columns 41, a most proximate one of the first split pillars 410 is most proximate to the second side 332. In each of the plurality of first DLD arrays 4, the leading one and the trailing one of the first DLD columns 41 are respectively most distal from and most proximate to the outlet 334, the most proximate ones of the first split pillars 410 of the first DLD columns 41 shift along a first reference line (L1). A second reference line (L2) extends along the length direction (L). An included angle (03) is formed between the first and second reference lines (L1, L2). The first split pillars 410 of the first DLD columns 41 in each of the plurality of first DLD arrays 4 cooperately define first drainage channels 416 in one of the two sorting areas 335, and the first drainage channels 416 are arranged along the width direction (W) and interconnected with one another. Each of the first drainage channels 416 extends from the inlet 333 obliquely along the length direction (L) toward the outlet 334 and the second side 332, that is to say, toward the collection area 336. Due to the lateral offset design of the first DLD columns 41, some of the first drainage channels 416 of the plurality of first DLD arrays 4 can thus be in fluid communication with one another in both the length and width directions (L, W) and in an offset manner.

In other words, each first DLD array 4 includes the first split pillars 410 arranged in rows and columns. The columns of the first split pillars 410 (i.e., the first DLD columns 41) are displaced from each other in the length direction (L), and the rows of the first split pillars 410 are displaced from each other in the width direction (W). From the inlet 333 to the outlet 334, the columns of the first split pillars 410 are gradually shifted toward the second side 332 such that each two adjacent ones of the first split pillars 410 in each row are offset from each other by the predetermined distance (Δd).

Each of the first split pillars 410 has a first upstream side 411 that faces the inlet 333 and a first downstream side 412 that faces the outlet 334, and includes two first parts 413 that respectively have two inward surfaces 414 facing each other and spaced apart in the width direction (W). That is to say, the two first parts 413 of each of the first split pillars 410 are spaced apart from each other to define a first micro-gap 415 which extends from the first upstream side 411 to the first downstream side 412. The first micro-gap 415 extends along a direction that forms a deflection angle (01) with respect to the length direction (L) so as to guide the non-target particles 902 to move toward the first side 331. The deflection angel (θ1) is not smaller than 1° and not greater than 89° (i.e., 1°≤θ1≤89°). In addition, the first micro-gap 415 has a gap width (Gp) with a dimension to allow the non-target particles 902, after deformation, to pass therethrough.

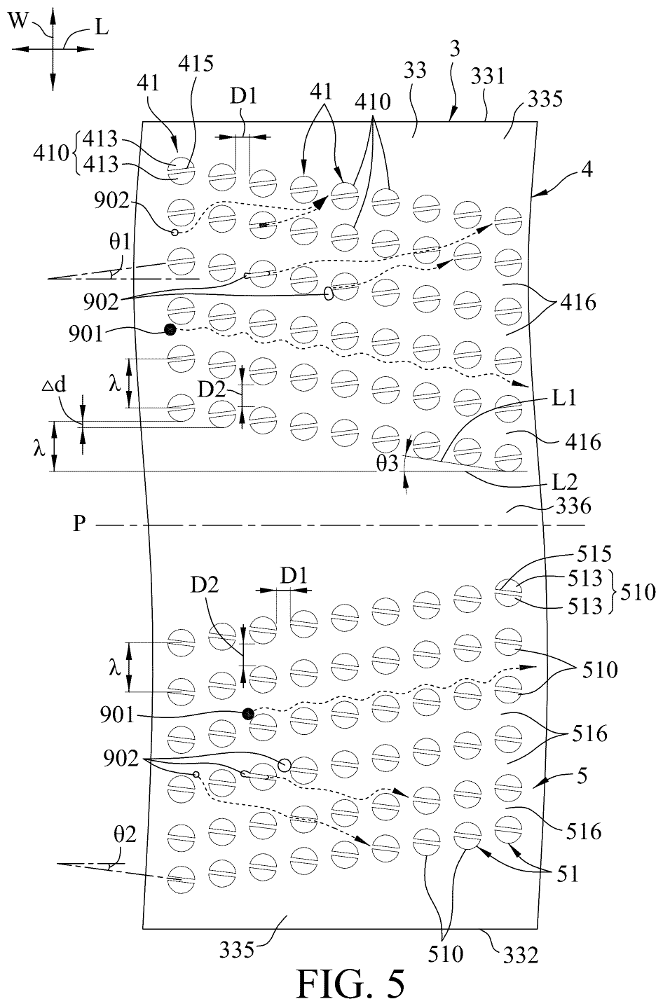

In the first embodiment, each of the first split pillars 410 is in the shape of substantially cylinder, and each of the two first parts 413 of each of the first split pillars 410 is in the shape of semi-cylinder. Therefore, the two first parts 413 of each of the first split pillars 410 are symmetrical with respect to each other in a plane defined by the length direction (L) and the width direction (W). The plane may be observed from, for example, a top view shown in FIG. 5. Moreover, the deflection angles (θ1) of the first micro-gaps 415 in the first split pillars 410 are the same, where θ1=8°.

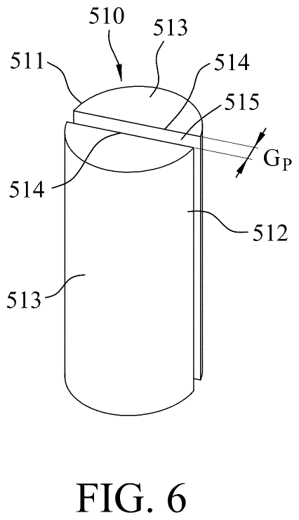

Referring to FIGS. 3, 5, and 6, each of the plurality of second DLD arrays 5 includes second DLD columns 51, and two adjacent ones of the second DLD columns 51 are spaced apart in the length direction (L) by the first pacing (D1). Each of the second DLD columns 51 has second split pillars 510, and two adjacent ones of the second split pillars 510 are spaced apart in the width direction (W) by the second spacing (D2) which is not smaller than the first spacing (D1) (i.e., D2 D1). Similar to the arrangement of the first split pillars 410 of the first DLD columns 41, the arrangement of the second split pillars 510 of the second DLD columns 51 also satisfies an equation of an equation of the form: 0.33<Dt/D2<1.2 where Dt and D2 are as described above. Additionally, a center-to-center distance of two adjacent ones of the second split pillars 510 of each of the second DLD columns 41 has the predetermined value (A).

The second DLD columns 51 of each of the plurality of second DLD arrays 5, from the inlet 333 toward the outlet 334, are gradually shifted toward the first side 331 such that two adjacent ones of the second DLD columns 51 are offset from each other by the predetermined distance (Δd). Moreover, the second split pillars 510 of a trailing one of the second DLD column 51 in one of the plurality of second DLD arrays 5 are respectively offset from the second split pillars 510 of a leading one of the second DLD column 51 in the one of the plurality of second DLD arrays 5 in the width direction (W) toward the first side 331 by the predetermined value (λ), and based upon the foregoing description, the number of the second DLD columns 51 in each of the plurality of second DLD arrays 5 can be adjusted and set. In each of the plurality of second DLD arrays 5, the leading one and the trailing one of the second DLD columns 51 are respectively most distal from and most proximate to the outlet 334. The second split pillars 510 of the second DLD columns 51 in each of the plurality of second DLD arrays 5 cooperately define second drainage channels 516 in the other one of the two sorting areas 335, and the second drainage channels 516 are arranged along the width direction (W) and interconnected with one another. Each of the second drainage channels 516 extends from the inlet 333 obliquely along the length direction (L) toward the outlet 334 and the first side 331, that is to say, toward the collection area 336. Due to the lateral offset design of the second DLD columns 51, some of the second drainage channels 516 of the plurality of second DLD arrays 5 can thus be in fluid communication with one another in both the length and width directions (L, W) and in an offset manner.

In other words, each second DLD array 5 includes the second split pillars 510 arranged in rows and columns. The columns of the second split pillars 510 (i.e., the second DLD columns 51) are displaced from each other in the length direction (L), and the rows of the second split pillars 510 are displaced from each other in the width direction (W). From the inlet 333 to the outlet 334, the columns of the second split pillars 510 are gradually shifted toward the first side 331 such that each two adjacent ones of the second split pillars 510 in each row are offset from each other by the predetermined distance (Δd).

Each of the second split pillars 510 has a second upstream side 511 that faces the inlet 333 and a second downstream side 512 that faces the outlet 334, and includes two second parts 513 that respectively have two inward surfaces 514 facing each other and spaced apart in the width direction (W). That is to say, the two second parts 513 of each of the second split pillars 510 are spaced apart from each other to define a second micro-gap 515 which extends from the second upstream side 511 to the second downstream side 512. The second micro-gap 515 extends along a direction that forms a deflection angle (θ2) with respect to the length direction (L) so as to guide the non-target particles 902 to move toward the second side 332. The deflection angel (02) is not smaller than 1° and not greater than 89° (i.e., 1°≤θ2≤89°). In addition, the second micro-gap 515 has a gap width (Gp) with a dimension to allow the non-target particles 902, after deformation, to pass therethrough.

In the first embodiment, each of the second split pillars 510 is in the shape of substantially cylinder, and each of the two second parts 513 of each of the second split pillars 510 is in the shape of semi-cylinder. Therefore, the two second parts 513 of each of the second split pillars 510 are symmetrical with respect to each other in the plane defined by the length direction (L) and the width direction (W). Moreover, the deflection angles (θ2) of the second micro-gaps 515 in the second split pillars 510 are the same, where θ2=8°.

Referring to FIGS. 2 to 5, when performing sorting by continuously guiding the buffer liquid to flow from the buffer injection channel 35 into the collection area 336, as well as by guiding the sample fluid to flow from the sample-fluid injection channel 34 into the two sorting areas 335, the microfluidic particle sorter 200 according to the disclosure, which is configured for sorting the target particles 901 (e.g., CTCs) and the non-target particles 902 (e.g. blood cells) in the sample fluid (e.g., a blood sample) by DLD, allows the buffer liquid to flow downstream toward the target-particle collection channel 37, and also allows the sample fluid to flow downstream toward the two waste-liquid outflow sections 361 through the first drainage channels 416 and the second drainage channels 516 respectively in the two sorting areas 335, thereby being discharged out therefrom.

During flow of the sample fluid and the buffer liquid, because compared with the non-target particles 902, the target particles 901 to be sorted have relatively large particle sizes and relatively small degrees of deformation, it is difficult for the target particles 901 to move toward a direction away from the collection area 336 and to pass through the first micro-gaps 415 of the first split pillars 410 or the second micro-gaps 515 of the second split pillars 510. As a result, the plurality of first DLD arrays 4 and the plurality of second DLD arrays 5 perform DLD by driving the target particles 901 to move downstream along the first drainage channels 416 of one of the plurality of first DLD arrays 4 or along the second drainage channels 516 of one of the plurality of second DLD arrays 5, and then to enter the first drainage channels 416 of a subsequent one of the plurality of first DLD arrays 4 or the second drainage channels 516 of a subsequent one of the plurality of second DLD arrays 5, so that the target particles 901 get closer to the collection area 336. Alternatively, the target particles 901 may directly enter the collection are 336 after passing through the first drainage channels 416 of the foregoing one of the plurality of first DLD arrays 4 or the second drainage channels 516 of the foregoing one of the plurality of second DLD arrays 5. Simultaneously, the non-target particles 902, due to having smaller particle sizes, can easily move toward a direction away from the collection area 336 and to pass through the first micro-gaps 415 of the first split pillars 410 or the second micro-gaps 515 of the second split pillars 510. Thus, the non-target particles 902 gradually move away from the collection area 336 to approach the first side 331 and the second side 332 where they will be collected. Therefore, the target particles 901 thus sorted will be collected and obtained from the target-particle collection channel 37, while the non-target particles 902 will be brought to the waste-liquid outflow channel 36.

Moreover, during flow of the sample fluid, some of the non-target particles 902, after in collision with the first upstream sides 411 of the first split pillars 410, or the second upstream sides 511 of the second split pillars 510, may directly pass through, or pass through after slight deformation, the first micro-gaps 415 of the first split pillars 410, or the second micro-gaps 515 of the second split pillars 510, thereby moving toward the first side 331 or the second side 332.

In some cases, some other ones of the non-target particles 902 in the sample fluid may have particle sizes similar to those of the target particles 901 and may be prone to deformation, like while blood cells. Such non-target particles 902, after in collision with the first upstream side 411 one of the first split pillars 410 or the second upstream side 511 of one of the second split pillars 510, can be deformed by a flow force of the sample fluid and hence squeezed into the first micro-gap 415 of the one of the first split pillars 410 or the second micro-gap 515 of the one of the second split pillars 510, so as to pass along the direction along which the first micro-gap 415 extends or along the direction along which the second micro-gap 515 extends, thereby being moved away from the collection area 336 toward the first side 331 or the second side 332.

With such design in the microfluidic particle sorter 200, the non-target particles 902 that have large particle sizes and are prone to deformation can be gradually guided toward a direction away from the collection area 336, thereby achieving the purpose for separating the target particles 901 and the non-target particles 902 that have similar particle sizes to those of the target particles 901.

Furthermore, the gap width (Gp) of the first micro-gap 415 of each of the first split pillars 410 and the gap width (Gp) of the second micro-gap 515 of each of the second split pillars 510 may be adjusted according to a desired recovery rate or purity of the target particles 901. Based upon the foregoing, two exemplary modes are given as follows.

### First Exemplary Mode: Mode of High Recovery Rate

The mode of high recovery rate refers to a mode that tends to maximize recovery rate of the target particles 901, thereby achieving the effect of sorting out most of the target particles 901 in the sample fluid. In this mode, the gap width (Gp) of the first micro-gap 415 of each of the first split pillars 410 and the gap width (Gp) of the second micro-gap 515 of each of the second split pillars 510 need to be adjusted to satisfy the following equation: 0.2Dt<Gp<0.8Dt where Dt and Gp are as described above.

### Second Exemplary Mode: Mode of High Purity

The mode of high purity refers to a mode that tends to maximize purity of the target particles 901 collected in the target-particle collection channel 37, in other words, most of the non-target particles 902 in the sample fluid can be separated into the two waste-liquid outflow sections 361. In this mode, the gap width (Gp) of the first micro-gap 415 of each of the first split pillars 410 and the gap width (Gp) of the second micro-gap 515 of each of the second split pillars 510 need to be adjusted to satisfy the following equation: Ddnt<Gp<0.8Dt where Dt, Ddnt and Gp are as described above.

For instance, if the particle size (Dt) of the smallest one of the target particles 901 is 15 μm, and the narrow side width (Ddnt) of the largest one of the non-target particles 902 after the greatest degree of deformation thereof is less than 6 μm, arrangement of the plurality of first DLD arrays 4 and the plurality of second DLD arrays 5 can be as follows: Gp=6 μm; D1=20 μm; D2=32 μm; Δd=0.9 μm; and λ=68 μm. By such layout, most of the target particles 901 in the sample fluid can be driven to move toward the collection area 336, thereby being sorted out.

In order to maximize recovery rate of the target particles 901, the gap width (Gp) of the first micro-gap 415 of each of the first split pillars 410 and the gap width (Gp) of the second micro-gap 515 of each of the second split pillars 510 can be designed to be 3 μm. With such design, most of the target particles 901 can be sorted into the collection area 336, but some of the non-target particles 902 may not be able to pass through the first micro-gap 415 or the second micro-gap 515 even after deformation due to the gap width (Gp) of the first micro-gap 415 and gap width (Gp) of second micro-gap 515 being too small, so that the some of the non-target particles 902 that have greater particle sizes will be sorted into the collection area 336 along with the target particles 901.

In order to optimize purity of the target particles 901 to be collected, the gap width (Gp) of the first micro-gap 415 of each of the first split pillars 410 and the gap width (Gp) of the second micro-gap 515 of each of the second split pillars 510 can be designed to be 12 μm. With such design, most of the non-target particles 902 can easily pass through the first micro-gap 415 and the second micro-gap 515 after deformation, so as to be retained in the two sorting areas 335, thereby raising purity of the target particles 901 that are sorted into the collection area 336. However, a risk that the target particles 901 pass through or get stuck in the first micro-gap 415 and/or the second micro-gap 515 after performing a slight degree of deformation may increase, resulting in some of the target particles 901 not being sorted into the collection area 336.

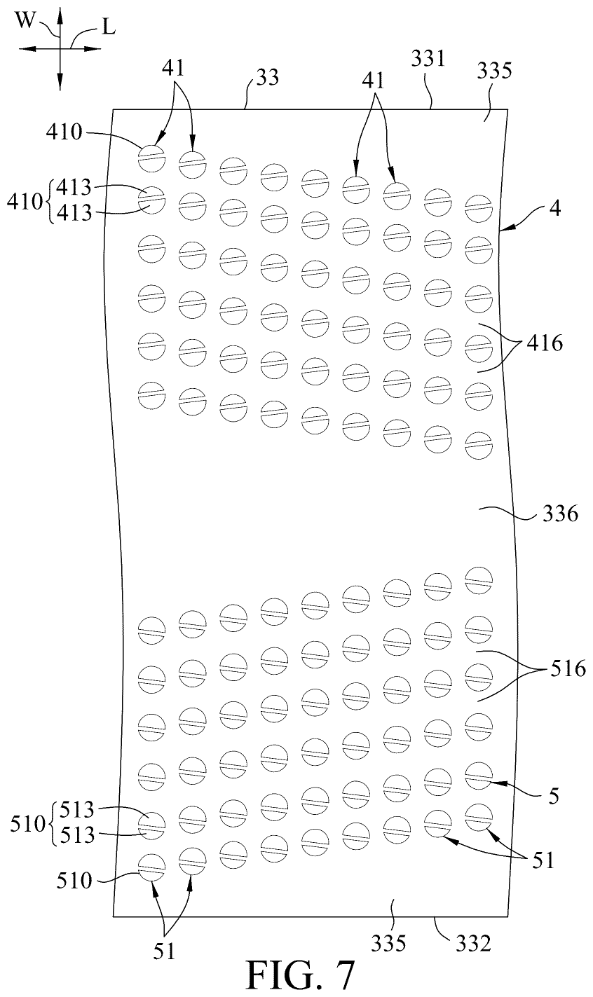

Referring to FIGS. 5 and 7, in the first embodiment, each of the first split pillars 410 or each of the second split pillars 510 has an overall appearance of cylindrical shape, each of the two first parts 413 or each of the two second parts 513 is in the shape of semi-cylinder. As shown in FIG. 5, the two first parts 413 of each of the first split pillars 410 or the two second parts 513 of each of the second split pillars 510 are symmetrical with respect to each other in the plane defined by the length direction (L) and the width direction (W). In the modified first embodiment, as shown in FIG. 7, each of the first split pillars 410 or each of the second split pillars 510, though having the overall appearance of cylindrical shape, is asymmetrically cut such that the two first parts 413 of each of the first split pillars 410 or the two second parts 513 of each of the second split pillars 510 are asymmetrical with respect to each other.

In a situation where the two first parts 413 of each of the first split pillars 410 and the two second parts 513 of each of the second split pillars 510 are asymmetrical with respect to each other, the first spit pillars 410 and the second split pillars 510 may be arranged in a manner as shown in FIG. 7. Specifically, in such arrangement shown in FIG. 7, one of the two first parts 413 (located closer to the collection area 336) has a volume greater than that of the other of the two first parts 413 (located remote from the collection area 336); and one of the two second parts 513 (located closer to the collection area 336) has a volume greater than that of the other of the two second parts 513 (located remote from the collection area 336). Therefore, the first and second pillars 4, 5 may be arranged to be symmetrical with respect to each other as long as an opening of the first micro-gap 415 of each of the first split pillars 410 and an opening of the second micro-gap 515 of each of the second split pillars 510 are respectively located at the first upstream side 411 and at the second upstream side 511, namely, as long as the non-target particles 902, after deformation, can be guided by the first micro-gap 415 or the second micro-gap 515 to pass downstream therethrough.

Moreover, the deflection angles (θ1) of the first micro-gaps 415 in the first split pillars 410 (or the deflection angles (θ2) of the second micro-gaps 515 in the second split pillars 510) are not necessarily the same. The deflection angles (θ1) of the first micro-gaps 415 of the first split pillars 410 in one of the first DLD columns 41 may be different, and the deflection angles (θ2) of the second micro-gaps 515 of the second split pillars 510 in one of the second DLD columns 51 may be different as well.

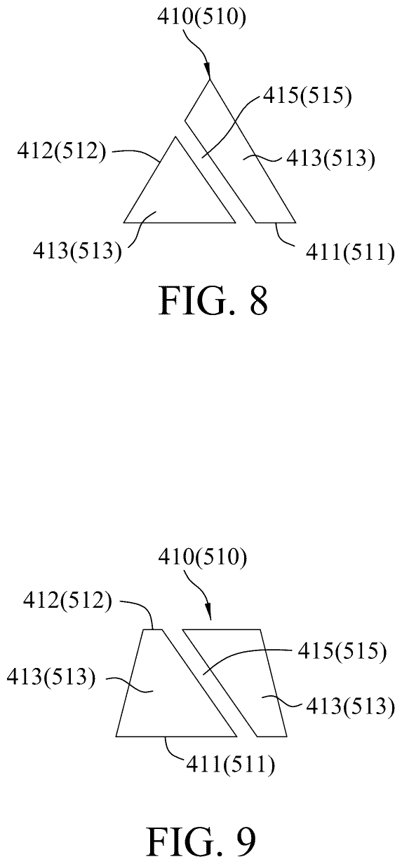

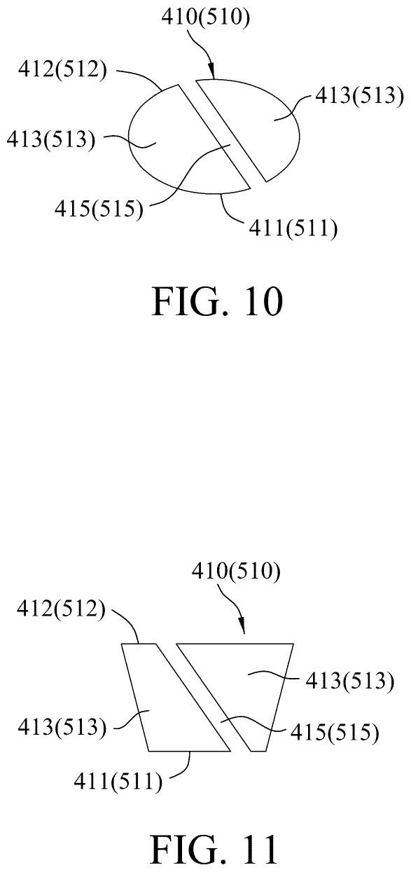

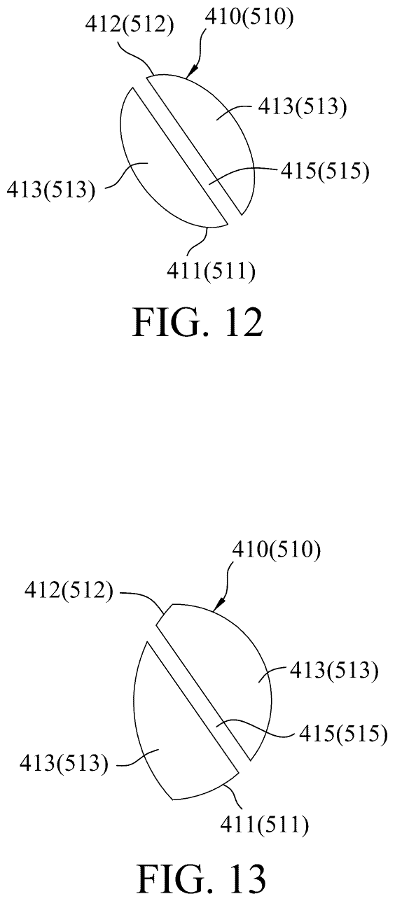

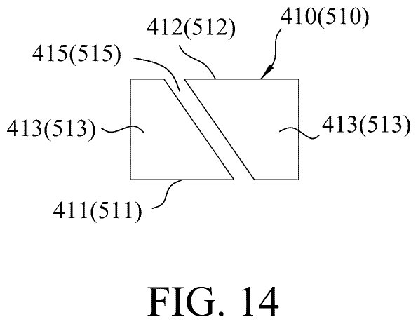

In addition to the cylindrical shape as mentioned above, in other embodiments, the first split pillars 410 and the second split pillars 510 may also be designed in other shapes, such as the shapes shown in FIGS. 8 to 14. However, examples of shapes are not limited thereto, as long as the first micro-gap 415 of each of the first split pillars 410 extends obliquely, from the first upstream side 411 to the first downstream side 412, away from the collection area 336, and the second micro-gap 515 of each of the second split pillars 510 extends obliquely, from the second upstream side 511 to the second downstream side 512, away from the collection area 336, namely, as long as the non-target particles 902, after deformation, can be guided to pass through the first micro-gap 415 and the second micro-gap 515 in a direction away from the collection area 336.

Take the following as a sorting example, where CTCs were used to serve as the target particles 901, and a phosphate buffered saline (PBS) was used to serve as the buffer liquid. The sample fluid of this example was prepared by diluting a blood of a healthy human (blood cells therein serve as the non-target particles 902) tenfold with the PBS, followed by adding thereto a certain number of the CTCs. Subsequently, the microfluidic particle sorter 200 according to the disclosure was subjected to a sorting test utilizing the sample fluid, so as to sort the CTCs and the blood cells (i.e., while blood cells (WBCs) and red blood cells (RBCs)) in the sample fluid. The structural parameters of the microfluidic particle sorter 200 were as follows: D1=20 μm; D2=32 μm; Δd=0.9 μm; and λ=68 μm. Each of the first split pillars 410 and the second split pillars 510 was asymmetrically and obliquely cut. Each of the first micro-gaps 415 had the gap width (Gp) of 6 μm, and so did each of the second micro-gaps 515. The deflection angles (θ1) of the first micro-gaps 415 and the deflection angles (θ2) of the second micro-gaps 515 were 8°. The sample fluid had a flow rate of 12 mL/hr, and the buffer liquid (i.e., the PBS) had a flow rate, as being injected into the buffer injection channel 35, of 85 mL/hr.

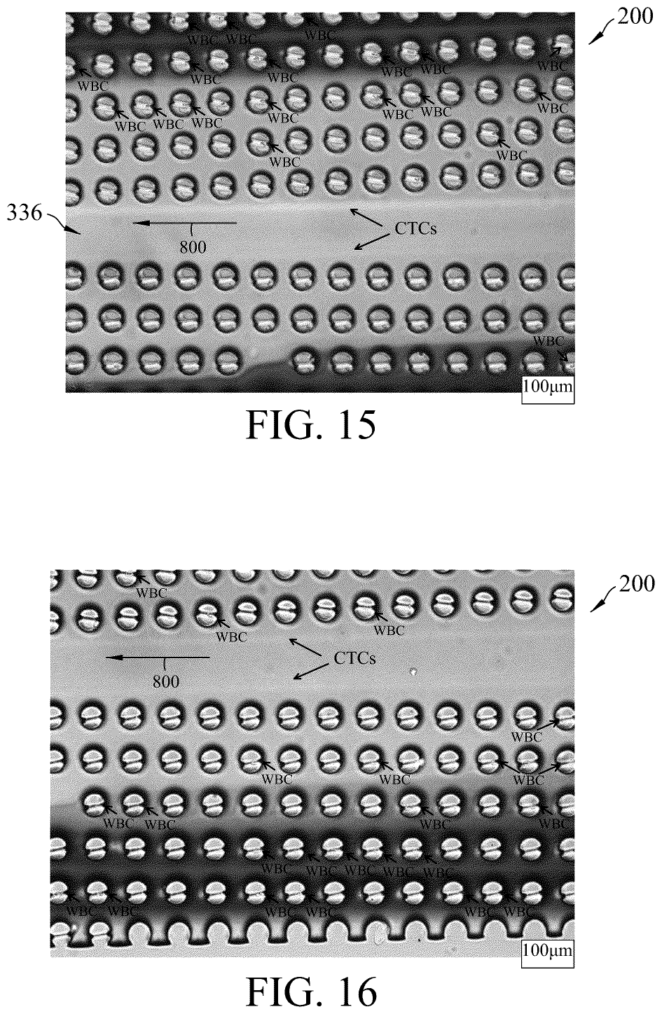

Referring to FIGS. 15 to 17, microscopic images of different parts, along a flow direction 800 of the sample fluid, of the microfluidic particle sorter 200 according to the disclosure were shown.

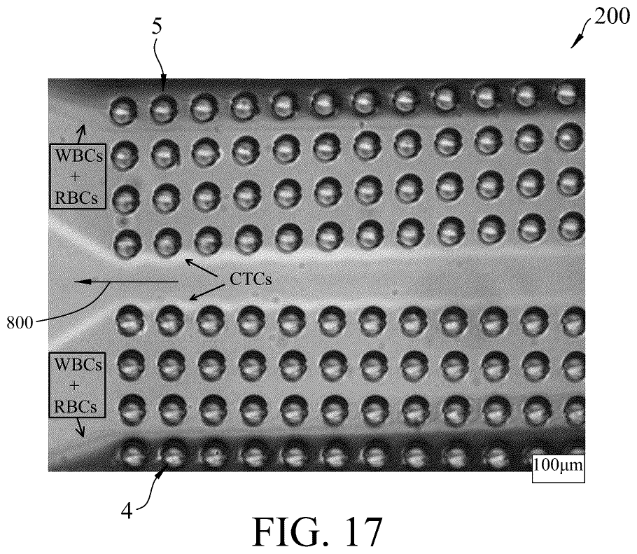

As shown in FIGS. 15 and 16, the CTCs migrated to and concentrated at the collection area 336, while the blood cells (i.e., WBCs and RBCs) were guided away from the collection area 336. Some of the WBCs were deformed so as to squeeze in and pass through the first micro-gaps 415 of the first split pillars 410 or the second micro-gaps 515 of the second split pillars 510. Referring to FIG. 17, when the CTCs and the blood cells went through a final one of the plurality of first DLD arrays 4 and a final one of the plurality of second DLD arrays 5, it could be clearly seen that the CTCs and the blood cells in the sample fluid were indeed separated, confirming that the CTCs could be sorted out from the sample fluid.

Next, purity test was conducted as follows. Initially, A549/GFP tumor cells were used to serve as the target particles 901, and then a certain number of the A549/GFP tumor cells were added to and mixed with a blood sample (having blood cells that served as the non-target particles 901 therein), so as to obtain a blood-A549 sample fluid (serving as the sample fluid). Thereafter, the microfluidic particle sorter 200 according to the disclosure was subjected to the purity test using the blood-A549 sample fluid, so as to estimate purity of the A549/GFP tumor cells obtained after undergoing sorting, that is to say, purity of the A549/GFP tumor cells in the target liquid collected from the collection area 336. For comparison purpose, a sorter with a conventional DLD structure was also subjected to the purity test using the blood-A549 sample fluid, so as to estimate purity of the A549/GFP tumor cells obtained after undergoing sorting.

To be more specific, each of the microfluidic particle sorter 200 and the sorter with the conventional DLD structure was subjected to the purity test using the blood-A549 sample fluid, and an amount of the blood-A549 sample fluid used each time was 5 mL. After sorting, a number of the A549/GFP tumor cells and a number of the blood cells in the target liquid would be calculated using a microscopic imaging technique, so as to statistically analyze a recovery rate and a purity of the A549/GFP tumor cells (i.e., target particles 901) in the target liquid.

Precisely speaking, in the foregoing purity test, the buffer liquid was a PBS. In addition, the blood-A549 sample fluid was obtained by diluting a blood of a healthy human tenfold with the PBS, followed by adding thereto the A549/GFP tumor cells having a number ranging from 29 to 91. The blood-A549 sample fluid had a flow rate, as flowing through the two sample-fluid injection sections 341, of 12 mL/hr, and the buffer liquid (i.e., the PBS) had a flow rate, as being injected into the buffer injection channel 35, of 85 mL/hr.

The structural configuration of the sorter with the conventional DLD structure was similar to that of the microfluidic particle sorter 200, except that the sorter with the conventional DLD structure did not have the first micro-gaps 415 as those in the first split pillars 410 and the second micro-gaps 515 as those in the second split pillars 510. The structural parameters of the microfluidic particle sorter 200 used for the purity test were as follows: D1=20 μm; D2=32 μm; Δd=0.9 μm; and λ=68 μm. Each of the first split pillars 410 and the second split pillars 510 was asymmetrically and obliquely cut. Each of the first micro-gaps 415 had the gap width (Gp) of 6 μm, and so did each of the second micro-gaps 515. The deflection angles (θ1) of the first micro-gaps 415 and the deflection angles (θ2) of the second micro-gaps 515 were 8°.

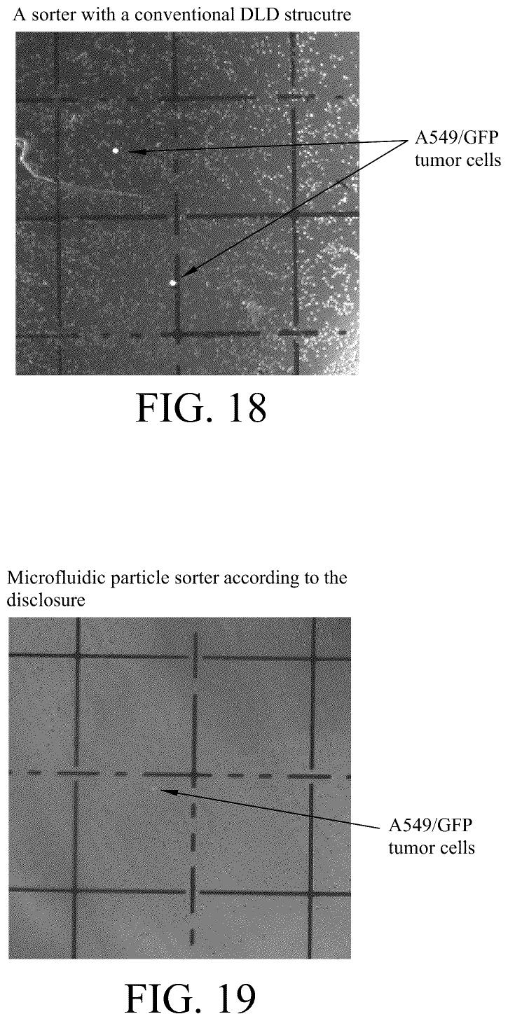

Referring to FIGS. 18 and 19, two microscopic images of target liquids which are respectively sorted by the sorter with the conventional DLD structure and the microfluidic particle sorter 200. In the target liquids shown in FIGS. 18 and 19, the marked particles were the A549/GFP tumor cells, and the remaining particles therein were the blood cells. Compared with the target liquid collected from the sorter with the conventional DLD structure, the number of the blood cells left in the target liquid, after sorting by the microfluidic particle sorter 200, was significantly decreased. Specifically, the purity of the target liquid sorted by the microfluidic particle sorter 200 according to the disclosure increased 1 to 2 logs.

Referring to Table 1, the results showed that by using the microfluidic particle sorter 200 according to the disclosure, an average recovery rate of the A549/GFP tumor cells was 86% (N=8), with the highest recovery rate reaching up to 95.5%, and the lowest recovery rate of 78.1%.

TABLE 1

| | Number of | Number of | Recovery |
|---|---|---|---|
| | A549/GFP tumor | A549/GFP tumor | rate of |
| | cells in blood- | cells in target | A549/GFP tumor |
| Number | A549 sample fluid | liquid | cells |
| 1 | 65 | 60 | 92.3% |
| 2 | 87 | 68 | 78.1% |
| 3 | 28 | 23 | 82.1% |
| 4 | 91 | 77 | 84.6% |
| 5 | 54 | 45 | 83.3% |
| 6 | 75 | 67 | 89.3% |
| 7 | 89 | 85 | 95.5% |
| 8 | 29 | 24 | 82.8% |

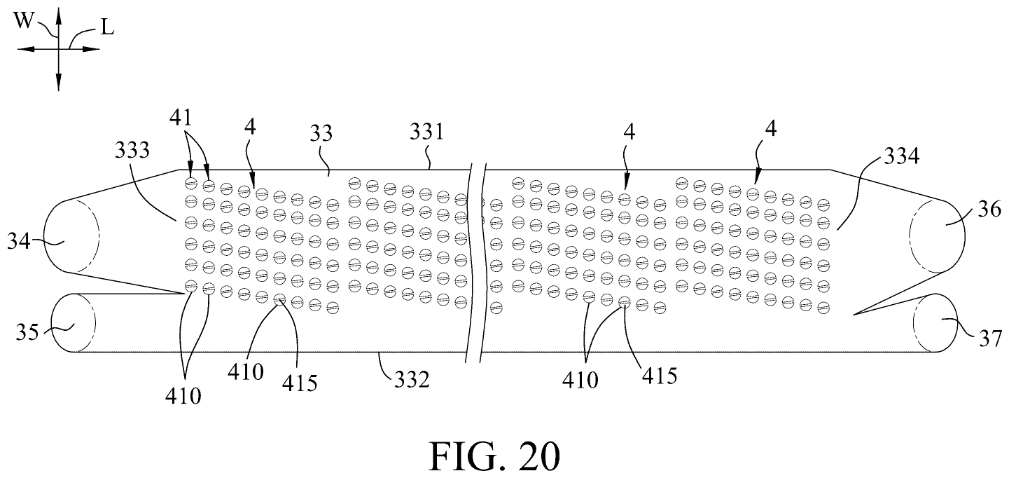

Referring to FIG. 20, a second embodiment of the microfluidic particle sorter 200 according to the disclosure differs from that of the first embodiment in that none of the plurality of second DLD arrays 5 are provided therein. For convenience of explanation, the following description only focuses on the differences between the foregoing two embodiments.

In the second embodiment, the microfluidic particle sorter 200 includes the chip body 3 and the single sorting unit which is provided inside the chip body 3. The sorting unit includes the microfluidic channel 33 and the plurality of first DLD arrays 4 disposed in the microfluidic channel 33 and arranged along the length direction (L). In addition, the sample-fluid injection channel 34 and the buffer injection channel 35 of the chip body 3 are respectively adjacent to the first side 331 and the second side 332 of the microfluidic channel 33, and the waste-liquid outflow channel 36 and the target-particle collection channel 37 thereof are respectively adjacent to the first side 331 and the second side 332. In other words, the buffer injection channel 35 and the sample-fluid injection channel 34 are located proximate to and distal from the second side 332, respectively, and the target-particle collection channel 37 and the waste-liquid outflow channel 36 are located proximate to and distal from the second side 332, respectively.

The plurality of first DLD arrays 4 are arranged from upstream to downstream along the microfluidic channel 33. The first micro-gap 415 of each of the first split pillars 410 extends from the first upstream side 411 to the first downstream side 412 obliquely along the length direction (L) toward the second side 332.

The microfluidic particle sorter 200 of the second embodiment may be utilized for sorting the target particles 901 and the non-target particles 902 by procedures substantially the same as those described with reference to the microfluidic particle sorter 200 of the first embodiment. Therefore, the procedures will not be described in detail below.

Moreover, in order to attain a desired recovery rate or purity of the target particles 901 after sorting, structural parameters of the microfluidic particle sorter 200 of the second embodiment may also be adjusted by referring to the description concerning the microfluidic particle sorter 200 of the first embodiment.

Furthermore, in the modified second embodiment, the microfluidic particle sorter 200 has only one of the plurality of first DLD arrays 4, which can also complete sorting of the target particles 901 and the non-target particles 902.

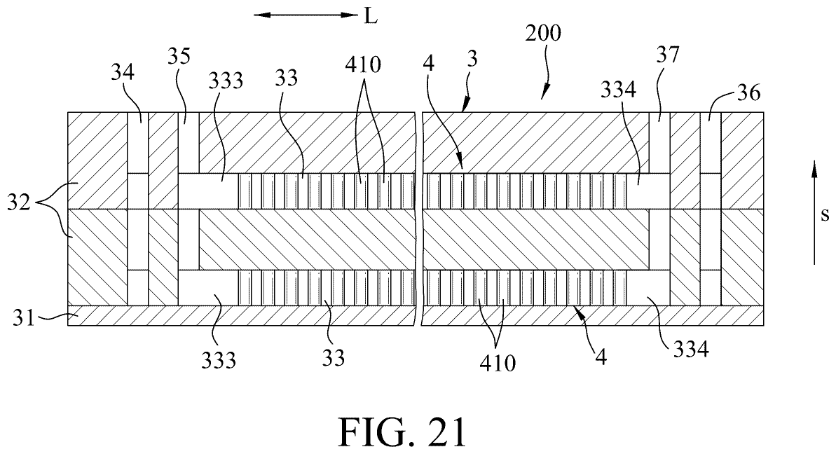

Referring to FIG. 21, a third embodiment of the microfluidic particle sorter 200 according to the disclosure is different from the microfluidic particle sorter 200 of the first embodiment (as shown in FIGS. 1 to 3) in that the at least one sorting unit of the microfluidic particle sorter 200 of the third embodiment includes two sorting units which are stacked on each other in a stacking direction (S).

Due to the two sorting units being stacked on each other in the stacking direction (S), the two microfluidic channels 33 of the two sorting units in the chip body 3 are spaced apart from each other in the stacking direction (S), with upstream ends (i.e., the two inlets 333) of the two microfluidic channels 33 being in fluid communication with each other, and downstream ends (i.e., the two outlets 334) of the two microfluidic channels 33 being in fluid communication with each other. In the third embodiment, the chip body 3 include the base 31, and two of the covers 32 stacked one above the other on the base 31. That is to say, a lower one of the two microfluidic channels 33 is defined cooperately by a lower one of the covers 32 and the base 31, and an upper one of the two microfluidic channels 33 is defined together by the covers 32. The sample-fluid injection channel 34 is in fluid communication with and upstream of the two inlets 333 of the two microfluidic channels 33, and the buffer injection channel 35 is in fluid communication with and upstream of the two inlets 333 of the two microfluidic channels 33. In addition, the waste-liquid outflow channel 36 is in fluid communication with and downstream of the two outlets 334 of the two microfluidic channels 33, and the target-particle collection channel 37 is in fluid communication with and downstream of the two outlets 334 of the two microfluidic channels 33.

In the microfluidic channel 33 of each of the two sorting units which has a configuration similar to FIG. 3, the plurality of first DLD arrays 4 are mirror-symmetrical to the plurality of second DLD arrays 5 with respect to the plane (P) in the length direction (L). Because in the third embodiment, arrangement of the plurality of first DLD arrays 4 and the plurality of second DLD arrays 5 in each of the two microfluidic channels 33 are the same as the that of the first embodiment, the arrangement thereof will not be further illustrated below.

Although the microfluidic particle sorter 200 of the third embodiment includes the two sorting units, in other embodiments, the microfluidic particle sorter 200 may include more than two sorting units, and each of the sorting units has the plurality of first DLD arrays 4 (and optionally the plurality of second DLD arrays 5) disposed on the microfluidic channel 33.

By having the two or more microfluidic channels 33 that are spaced apart from one another in the stacking direction (S), and by providing the plurality of first DLD arrays 4 and the plurality of second DLD arrays 5 in each of the microfluidic channels 33, the microfluidic particle sorter 200 according to the disclosure can be used to perform sorting of the target particles 901 and the non-target particles 902 in a large amount of the sample fluid, thereby improving processing efficiency.

In sum, in addition to being capable of sorting the target particles 901 and the non-target particles 902 having different particle sizes through adjusting arrangement of the split pillars 410 (or 510), by providing the micro-gap 415 (or 515) in each of the split pillars 410 (or 510) of the plurality of DLD arrays 4 (or 5), the non-target particles 902 having larger particle sizes are allowed to squeeze through the micro-gaps 415 (or 515) after deformation, so as to achieve the effect of sorting the target particles 901 and the non-target particles 902 that have similar particle sizes but different deformation capabilities, thereby enhancing efficiency of sorting the target particles 901 from the non-target particles 902 that have various particle sizes.

Moreover, by making the plurality of first DLD arrays 4 mirror-symmetrical to the plurality of second DLD arrays 5 with respect to the plane (P) in the length direction (L), the sorting efficiency of the target particles 901 and the non-target particles 902 can be further improved. Additionally, by adjusting the gap width (Gp) of the first micro-gap 415 or the second micro-gap 515, the recovery rate or purity of the target particles 901 can also be enhanced.

Accordingly, the microfluidic particle sorter 200 according to the disclosure is indeed innovative and hence can achieve the purpose of the invention.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A microfluidic particle sorter for sorting target particles and non-target particles in a sample fluid by deterministic lateral displacement (DLD), said microfluidic particle sorter comprising a chip body and at least one sorting unit which is provided inside said chip body and includes:
a microfluidic channel extending along a length direction, said microfluidic channel having an inlet and an outlet opposite to said inlet in the length direction, and having a first side and a second side opposite to said first side in a width direction; and
at least one first DLD array disposed in said microfluidic channel, and including first DLD columns that are arranged along the length direction, said first DLD columns, from said inlet toward said outlet, being gradually shifted toward said second side such that two adjacent ones of said first DLD columns are offset from each other by a predetermined distance, each of said first DLD columns having first split pillars that are disposed upright and spaced apart from one another along the width direction, each of said first split pillars having a first upstream side that faces said inlet and a first downstream side that faces said outlet, and including two first parts that are spaced apart from each other to define a first micro-gap which extends from said first upstream side to said first downstream side to allow the non-target particles, after deformation, to pass therethrough, said first micro-gap extending along a direction that forms a deflection angle with respect to the length direction so as to guide the non-target particles to move toward said first side, the deflection angle being not smaller than 1° and not greater than 89°, said first split pillars of said first DLD columns cooperately defining first drainage channels in said microfluidic channel that are arranged along the width direction and interconnected with one another, each of said first drainage channels extending from said inlet obliquely along the length direction toward said outlet and said second side.

2. The microfluidic particle sorter as claimed in claim 1, wherein the deflection angles of said first micro-gaps in said first split pillars are different from one another.

3. The microfluidic particle sorter as claimed in claim 1, wherein the deflection angles of said first micro-gaps in some of said first split pillars are the same, and are different from the deflection angles of said first micro-gaps in another some of said first split pillars.

4. The microfluidic particle sorter as claimed in claim 1, wherein said two first parts of each of said first split pillars are asymmetrical with respect to each other in a plane defined by the length direction and the width direction.

5. The microfluidic particle sorter as claimed in claim 1, wherein said two first parts of each of said first split pillars are symmetrical with respect to each other in a plane defined by the length direction and the width direction.

6. The microfluidic particle sorter as claimed in claim 1, wherein arrangement of said first split pillars of said first DLD columns satisfies the following equations:
Dt>Ddnt;
D2≥D1;
0.33<Dt/D2<1.2; and
Ddnt<Gp<0.8Dt,
where Dt is a particle size of a smallest one of the target particles,
Ddnt is a narrow side width of a largest one of the non-target particles after deformation,
D1 is a spacing between two adjacent ones of said first split pillars that are spaced apart in the length direction,
D2 is a spacing between two adjacent ones of said first split pillars of each of said first DLD columns,
Gp is a gap width of said first micro-gap.

7. The microfluidic particle sorter as claimed in claim 1, wherein arrangement of said first split pillars of said first DLD columns satisfies the following equations:
Dt>Ddnt;
D2≥D1;
0.33<Dt/D2<1.2; and
0.2Dt<Gp<0.6Dt,
where Dt is a particle size of a smallest one of the target particles,
Ddnt is a narrow side width of a largest one of the non-target particles after deformation,
D1 is a spacing between two adjacent ones of said first split pillars that are spaced apart in the length direction,
D2 is a spacing between two adjacent ones of said first split pillars of each of said first DLD columns, and
Gp is a gap width of said first micro-gap.

8. The microfluidic particle sorter as claimed in claim 1, wherein said at least one sorting unit further includes at least one second DLD array disposed in said microfluidic channel, said at least one second DLD array being mirror-symmetrical to said at least one first DLD array with respect to a plane in the length direction.

9. The microfluidic particle sorter as claimed in claim 2, wherein said at least one sorting unit further includes at least one second DLD array disposed in said microfluidic channel, said at least one second DLD array being mirror-symmetrical to said at least one first DLD array with respect to a plane in the length direction.

10. The microfluidic particle sorter as claimed in claim 3, wherein said at least one sorting unit further includes at least one second DLD array disposed in said microfluidic channel, said at least one second DLD array being mirror-symmetrical to said at least one first DLD array with respect to a plane in the length direction.

11. The microfluidic particle sorter as claimed in claim 4, wherein said at least one sorting unit further includes at least one second DLD array disposed in said microfluidic channel, said at least one second DLD array being mirror-symmetrical to said at least one first DLD array with respect to a plane in the length direction.

12. The microfluidic particle sorter as claimed in claim 5, wherein said at least one sorting unit further includes at least one second DLD array disposed in said microfluidic channel, said at least one second DLD array being mirror-symmetrical to said at least one first DLD array with respect to a plane in the length direction.

13. The microfluidic particle sorter as claimed in claim 6, wherein said at least one sorting unit further includes at least one second DLD array disposed in said microfluidic channel, said at least one second DLD array being mirror-symmetrical to said at least one first DLD array with respect to a plane in the length direction.

14. The microfluidic particle sorter as claimed in claim 7, wherein said at least one sorting unit further includes at least one second DLD array disposed in said microfluidic channel, said at least one second DLD array being mirror-symmetrical to said at least one first DLD array with respect to a plane in the length direction.

15. The microfluidic particle sorter as claimed in claim 1, wherein said at least one first DLD array includes a plurality of first DLD arrays disposed in said microfluidic channel and displaced from each other along the length direction, a center-to-center distance of two adjacent ones of said first split pillars of each of said first DLD columns being a predetermined value, said first split pillars of a trailing one of said first DLD column in one of said first DLD arrays being respectively offset from said first split pillars of a leading one of said first DLD column in said one of said first DLD arrays in the width direction toward said second side by the predetermined value.

16. The microfluidic particle sorter as claimed in claim 2, wherein said at least one first DLD array includes a plurality of first DLD arrays disposed in said microfluidic channel and displaced from each other along the length direction, a center-to-center distance of two adjacent ones of said first split pillars of each of said first DLD columns being a predetermined value, said first split pillars of a trailing one of said first DLD column in one of said first DLD arrays being respectively offset from said first split pillars of a leading one of said first DLD column in said one of said first DLD arrays in the width direction toward said second side by the predetermined value.

17. The microfluidic particle sorter as claimed in claim 3, wherein said at least one first DLD array includes a plurality of first DLD arrays disposed in said microfluidic channel and displaced from each other along the length direction, a center-to-center distance of two adjacent ones of said first split pillars of each of said first DLD columns being a predetermined value, said first split pillars of a trailing one of said first DLD column in one of said first DLD arrays being respectively offset from said first split pillars of a leading one of said first DLD column in said one of said first DLD arrays in the width direction toward said second side by the predetermined value.

18. The microfluidic particle sorter as claimed in claim 4, wherein said at least one first DLD array includes a plurality of first DLD arrays disposed in said microfluidic channel and displaced from each other along the length direction, a center-to-center distance of two adjacent ones of said first split pillars of each of said first DLD columns being a predetermined value, said first split pillars of a trailing one of said first DLD column in one of said first DLD arrays being respectively offset from said first split pillars of a leading one of said first DLD column in said one of said first DLD arrays in the width direction toward said second side by the predetermined value.

19. The microfluidic particle sorter as claimed in claim 5, wherein said at least one first DLD array includes a plurality of first DLD arrays disposed in said microfluidic channel and displaced from each other along the length direction, a center-to-center distance of two adjacent ones of said first split pillars of each of said first DLD columns being a predetermined value, said first split pillars of a trailing one of said first DLD column in one of said first DLD arrays being respectively offset from said first split pillars of a leading one of said first DLD column in said one of said first DLD arrays in the width direction toward said second side by the predetermined value.

20. The microfluidic particle sorter as claimed in claim 6, wherein said at least one first DLD array includes a plurality of first DLD arrays disposed in said microfluidic channel and displaced from each other along the length direction, a center-to-center distance of two adjacent ones of said first split pillars of each of said first DLD columns being a predetermined value, said first split pillars of a trailing one of said first DLD column in one of said first DLD arrays being respectively offset from said first split pillars of a leading one of said first DLD column in said one of said first DLD arrays in the width direction toward said second side by the predetermined value.

21. The microfluidic particle sorter as claimed in claim 7, wherein said at least one first DLD array includes a plurality of first DLD arrays disposed in said microfluidic channel and displaced from each other along the length direction, a center-to-center distance of two adjacent ones of said first split pillars of each of said first DLD columns being a predetermined value, said first split pillars of a trailing one of said first DLD column in one of said first DLD arrays being respectively offset from said first split pillars of a leading one of said first DLD column in said one of said first DLD arrays in the width direction toward said second side by the predetermined value.

22. The microfluidic particle sorter as claimed in claim 15, wherein said at least one sorting unit further includes a plurality of second DLD arrays disposed in said microfluidic channel and arranged along the length direction toward said outlet, said plurality of second DLD arrays being mirror-symmetrical to said plurality of first DLD arrays with respect to a plane in the length direction.

23. The microfluidic particle sorter as claimed in claim 16, wherein said at least one sorting unit further includes a plurality of second DLD arrays disposed in said microfluidic channel and arranged along the length direction toward said outlet, said plurality of second DLD arrays being mirror-symmetrical to said plurality of first DLD arrays with respect to a plane in the length direction.

24. The microfluidic particle sorter as claimed in claim 17, wherein said at least one sorting unit further includes a plurality of second DLD arrays disposed in said microfluidic channel and arranged along the length direction toward said outlet, said plurality of second DLD arrays being mirror-symmetrical to said plurality of first DLD arrays with respect to a plane in the length direction.

25. The microfluidic particle sorter as claimed in claim 18, wherein said at least one sorting unit further includes a plurality of second DLD arrays disposed in said microfluidic channel and arranged along the length direction toward said outlet, said plurality of second DLD arrays being mirror-symmetrical to said plurality of first DLD arrays with respect to a plane in the length direction.

26. The microfluidic particle sorter as claimed in claim 19, wherein said at least one sorting unit further includes a plurality of second DLD arrays disposed in said microfluidic channel and arranged along the length direction toward said outlet, said plurality of second DLD arrays being mirror-symmetrical to said plurality of first DLD arrays with respect to a plane in the length direction.

27. The microfluidic particle sorter as claimed in claim 20, wherein said at least one sorting unit further includes a plurality of second DLD arrays disposed in said microfluidic channel and arranged along the length direction toward said outlet, said plurality of second DLD arrays being mirror-symmetrical to said plurality of first DLD arrays with respect to a plane in the length direction.

28. The microfluidic particle sorter as claimed in claim 21, wherein said at least one sorting unit further includes a plurality of second DLD arrays disposed in said microfluidic channel and arranged along the length direction toward said outlet, said plurality of second DLD arrays being mirror-symmetrical to said plurality of first DLD arrays with respect to a plane in the length direction.

29. The microfluidic particle sorter as claimed in claim 1, wherein said chip body includes a sample-fluid injection channel and a buffer injection channel that are spaced apart from each other in the width direction and are disposed upstream of said inlet, and
a waste-liquid outflow channel and a target-particle collection channel that are spaced apart from each other in the width direction and are disposed downstream of said outlet, said buffer injection channel and said sample-fluid injection channel being located proximate to and distal from said second side, respectively, said target-particle collection channel and said waste-liquid outflow channel being located proximate to and distal from said second side, respectively.

30. The microfluidic particle sorter as claimed in claim 22, wherein
said microfluidic channel has two sorting areas and a collection area located between said two sorting areas, said plurality of first DLD arrays being located in one of said two sorting areas, said plurality of second DLD arrays being located in the other one of said two sorting areas,
said chip body includes
a sample-fluid injection channel and a buffer injection channel that are spaced apart from each other and are located upstream of said inlet, said sample-fluid injection channel including two sample-fluid injection sections that are respectively located upstream of said two sorting areas so as to guide the sample fluid to flow into said two sorting areas, said buffer injection channel being located between said two sample-fluid injection sections and upstream of said collection area so as to guide a buffer liquid to flow into said collection area, and
a waste-liquid outflow channel and a target-particle collection channel that are spaced apart from each other and are located downstream of said outlet, said waste-liquid outflow channel including two waste-liquid outflow sections that are respectively located downstream of said two sorting areas so as to discharge a waste liquid from said two sorting areas, said target-particle collection channel being located between said two waste-liquid outflow sections and downstream of said collection area so as to collect a target liquid from said collection area.

31. The microfluidic particle sorter as claimed in claim 23, wherein
said microfluidic channel has two sorting areas and a collection area located between said two sorting areas, said plurality of first DLD arrays being located in one of said two sorting areas, said plurality of second DLD arrays being located in the other one of said two sorting areas,
said chip body includes
a sample-fluid injection channel and a buffer injection channel that are spaced apart from each other and are located upstream of said inlet, said sample-fluid injection channel including two sample-fluid injection sections that are respectively located upstream of said two sorting areas so as to guide the sample fluid to flow into said two sorting areas, said buffer injection channel being located between said two sample-fluid injection sections and upstream of said collection area so as to guide a buffer liquid to flow into said collection area, and
a waste-liquid outflow channel and a target-particle collection channel that are spaced apart from each other and are located downstream of said outlet, said waste-liquid outflow channel including two waste-liquid outflow sections that are respectively located downstream of said two sorting areas so as to discharge a waste liquid from said two sorting areas, said target-particle collection channel being located between said two waste-liquid outflow sections and downstream of said collection area so as to collect a target liquid from said collection area.

32. The microfluidic particle sorter as claimed in claim 24, wherein
said microfluidic channel has two sorting areas and a collection area located between said two sorting areas, said plurality of first DLD arrays being located in one of said two sorting areas, said plurality of second DLD arrays being located in the other one of said two sorting areas,
said chip body includes
a sample-fluid injection channel and a buffer injection channel that are spaced apart from each other and are located upstream of said inlet, said sample-fluid injection channel including two sample-fluid injection sections that are respectively located upstream of said two sorting areas so as to guide the sample fluid to flow into said two sorting areas, said buffer injection channel being located between said two sample-fluid injection sections and upstream of said collection area so as to guide a buffer liquid to flow into said collection area, and
a waste-liquid outflow channel and a target-particle collection channel that are spaced apart from each other and are located downstream of said outlet, said waste-liquid outflow channel including two waste-liquid outflow sections that are respectively located downstream of said two sorting areas so as to discharge a waste liquid from said two sorting areas, said target-particle collection channel being located between said two waste-liquid outflow sections and downstream of said collection area so as to collect a target liquid from said collection area.

33. The microfluidic particle sorter as claimed in claim 25, wherein
said microfluidic channel has two sorting areas and a collection area located between said two sorting areas, said plurality of first DLD arrays being located in one of said two sorting areas, said plurality of second DLD arrays being located in the other one of said two sorting areas,
said chip body includes
a sample-fluid injection channel and a buffer injection channel that are spaced apart from each other and are located upstream of said inlet, said sample-fluid injection channel including two sample-fluid injection sections that are respectively located upstream of said two sorting areas so as to guide the sample fluid to flow into said two sorting areas, said buffer injection channel being located between said two sample-fluid injection sections and upstream of said collection area so as to guide a buffer liquid to flow into said collection area, and
a waste-liquid outflow channel and a target-particle collection channel that are spaced apart from each other and are located downstream of said outlet, said waste-liquid outflow channel including two waste-liquid outflow sections that are respectively located downstream of said two sorting areas so as to discharge a waste liquid from said two sorting areas, said target-particle collection channel being located between said two waste-liquid outflow sections and downstream of said collection area so as to collect a target liquid from said collection area.

34. The microfluidic particle sorter as claimed in claim 26, wherein
said microfluidic channel has two sorting areas and a collection area located between said two sorting areas, said plurality of first DLD arrays being located in one of said two sorting areas, said plurality of second DLD arrays being located in the other one of said two sorting areas,
said chip body includes
a sample-fluid injection channel and a buffer injection channel that are spaced apart from each other and are located upstream of said inlet, said sample-fluid injection channel including two sample-fluid injection sections that are respectively located upstream of said two sorting areas so as to guide the sample fluid to flow into said two sorting areas, said buffer injection channel being located between said two sample-fluid injection sections and upstream of said collection area so as to guide a buffer liquid to flow into said collection area, and
a waste-liquid outflow channel and a target-particle collection channel that are spaced apart from each other and are located downstream of said outlet, said waste-liquid outflow channel including two waste-liquid outflow sections that are respectively located downstream of said two sorting areas so as to discharge a waste liquid from said two sorting areas, said target-particle collection channel being located between said two waste-liquid outflow sections and downstream of said collection area so as to collect a target liquid from said collection area.

35. The microfluidic particle sorter as claimed in claim 27, wherein
said microfluidic channel has two sorting areas and a collection area located between said two sorting areas, said plurality of first DLD arrays being located in one of said two sorting areas, said plurality of second DLD arrays being located in the other one of said two sorting areas,
said chip body includes
a sample-fluid injection channel and a buffer injection channel that are spaced apart from each other and are located upstream of said inlet, said sample-fluid injection channel including two sample-fluid injection sections that are respectively located upstream of said two sorting areas so as to guide the sample fluid to flow into said two sorting areas, said buffer injection channel being located between said two sample-fluid injection sections and upstream of said collection area so as to guide a buffer liquid to flow into said collection area, and
a waste-liquid outflow channel and a target-particle collection channel that are spaced apart from each other and are located downstream of said outlet, said waste-liquid outflow channel including two waste-liquid outflow sections that are respectively located downstream of said two sorting areas so as to discharge a waste liquid from said two sorting areas, said target-particle collection channel being located between said two waste-liquid outflow sections and downstream of said collection area so as to collect a target liquid from said collection area.

36. The microfluidic particle sorter as claimed in claim 28, wherein
said microfluidic channel has two sorting areas and a collection area located between said two sorting areas, said plurality of first DLD arrays being located in one of said two sorting areas, said plurality of second DLD arrays being located in the other one of said two sorting areas,
said chip body includes
a sample-fluid injection channel and a buffer injection channel that are spaced apart from each other and are located upstream of said inlet, said sample-fluid injection channel including two sample-fluid injection sections that are respectively located upstream of said two sorting areas so as to guide the sample fluid to flow into said two sorting areas, said buffer injection channel being located between said two sample-fluid injection sections and upstream of said collection area so as to guide a buffer liquid to flow into said collection area, and
a waste-liquid outflow channel and a target-particle collection channel that are spaced apart from each other and are located downstream of said outlet, said waste-liquid outflow channel including two waste-liquid outflow sections that are respectively located downstream of said two sorting areas so as to discharge a waste liquid from said two sorting areas, said target-particle collection channel being located between said two waste-liquid outflow sections and downstream of said collection area so as to collect a target liquid from said collection area.

37. The microfluidic particle sorter as claimed in claim 1, wherein said at least one sorter unit includes two sorter units which are stacked on each other in a stacking direction such that said microfluidic channels of said two sorter units are spaced apart from each other in the stacking direction, said chip body including
a sample-fluid injection channel and a buffer injection channel that are spaced apart from each other in the width direction and are located upstream of said inlets of said microfluidic channels of said two sorter units, and
a waste-liquid outflow channel and a target-particle collection channel that are spaced apart from each other in the width direction and are located downstream of said outlets of said microfluidic channels of said two sorter units.

38. The microfluidic particle sorter as claimed in claim 2, wherein said at least one sorter unit includes two sorter units which are stacked on each other in a stacking direction such that said microfluidic channels of said two sorter units are spaced apart from each other in the stacking direction, said chip body including
a sample-fluid injection channel and a buffer injection channel that are spaced apart from each other in the width direction and are located upstream of said inlets of said microfluidic channels of said two sorter units, and
a waste-liquid outflow channel and a target-particle collection channel that are spaced apart from each other in the width direction and are located downstream of said outlets of said microfluidic channels of said two sorter units.

39. The microfluidic particle sorter as claimed in claim 3, wherein said at least one sorter unit includes two sorter units which are stacked on each other in a stacking direction such that said microfluidic channels of said two sorter units are spaced apart from each other in the stacking direction, said chip body including
a sample-fluid injection channel and a buffer injection channel that are spaced apart from each other in the width direction and are located upstream of said inlets of said microfluidic channels of said two sorter units, and
a waste-liquid outflow channel and a target-particle collection channel that are spaced apart from each other in the width direction and are located downstream of said outlets of said microfluidic channels of said two sorter units.

40. The microfluidic particle sorter as claimed in claim 4, wherein said at least one sorter unit includes two sorter units which are stacked on each other in a stacking direction such that said microfluidic channels of said two sorter units are spaced apart from each other in the stacking direction, said chip body including
a sample-fluid injection channel and a buffer injection channel that are spaced apart from each other in the width direction and are located upstream of said inlets of said microfluidic channels of said two sorter units, and
a waste-liquid outflow channel and a target-particle collection channel that are spaced apart from each other in the width direction and are located downstream of said outlets of said microfluidic channels of said two sorter units.

41. The microfluidic particle sorter as claimed in claim 5, wherein said at least one sorter unit includes two sorter units which are stacked on each other in a stacking direction such that said microfluidic channels of said two sorter units are spaced apart from each other in the stacking direction, said chip body including
a sample-fluid injection channel and a buffer injection channel that are spaced apart from each other in the width direction and are located upstream of said inlets of said microfluidic channels of said two sorter units, and
a waste-liquid outflow channel and a target-particle collection channel that are spaced apart from each other in the width direction and are located downstream of said outlets of said microfluidic channels of said two sorter units.

42. The microfluidic particle sorter as claimed in claim 6, wherein said at least one sorter unit includes two sorter units which are stacked on each other in a stacking direction such that said microfluidic channels of said two sorter units are spaced apart from each other in the stacking direction, said chip body including
a sample-fluid injection channel and a buffer injection channel that are spaced apart from each other in the width direction and are located upstream of said inlets of said microfluidic channels of said two sorter units, and
a waste-liquid outflow channel and a target-particle collection channel that are spaced apart from each other in the width direction and are located downstream of said outlets of said microfluidic channels of said two sorter units.

43. The microfluidic particle sorter as claimed in claim 7, wherein said at least one sorter unit includes two sorter units which are stacked on each other in a stacking direction such that said microfluidic channels of said two sorter units are spaced apart from each other in the stacking direction, said chip body including
a sample-fluid injection channel and a buffer injection channel that are spaced apart from each other in the width direction and are located upstream of said inlets of said microfluidic channels of said two sorter units, and
a waste-liquid outflow channel and a target-particle collection channel that are spaced apart from each other in the width direction and are located downstream of said outlets of said microfluidic channels of said two sorter units.

44. The microfluidic particle sorter as claimed in claim 37, wherein each of said two sorter units further includes at least one second DLD array disposed in said microfluidic channel, said at least one second DLD array being mirror-symmetrical to said at least one first DLD array with respect to a plane in the length direction.

45. The microfluidic particle sorter as claimed in claim 38, wherein each of said two sorter units further includes at least one second DLD array disposed in said microfluidic channel, said at least one second DLD array being mirror-symmetrical to said at least one first DLD array with respect to a plane in the length direction.

46. The microfluidic particle sorter as claimed in claim 39, wherein each of said two sorter units further includes at least one second DLD array disposed in said microfluidic channel, said at least one second DLD array being mirror-symmetrical to said at least one first DLD array with respect to a plane in the length direction.

47. The microfluidic particle sorter as claimed in claim 40, wherein each of said two sorter units further includes at least one second DLD array disposed in said microfluidic channel, said at least one second DLD array being mirror-symmetrical to said at least one first DLD array with respect to a plane in the length direction.

48. The microfluidic particle sorter as claimed in claim 41, wherein each of said two sorter units further includes at least one second DLD array disposed in said microfluidic channel, said at least one second DLD array being mirror-symmetrical to said at least one first DLD array with respect to a plane in the length direction.

49. The microfluidic particle sorter as claimed in claim 42, wherein each of said two sorter units further includes at least one second DLD array disposed in said microfluidic channel, said at least one second DLD array being mirror-symmetrical to said at least one first DLD array with respect to a plane in the length direction.

50. The microfluidic particle sorter as claimed in claim 43, wherein each of said two sorter units further includes at least one second DLD array disposed in said microfluidic channel, said at least one second DLD array being mirror-symmetrical to said at least one first DLD array with respect to a plane in the length direction.

51. The microfluidic particle sorter as claimed in claim 44, wherein, in each of said two sorter units, said microfluidic channel has two sorting areas and a collection area located between said two sorting areas, said at least one first DLD array and said at least one second DLD array being located in said two sorting areas, respectively.

52. The microfluidic particle sorter as claimed in claim 45, wherein, in each of said two sorter units, said microfluidic channel has two sorting areas and a collection area located between said two sorting areas, said at least one first DLD array and said at least one second DLD array being located in said two sorting areas, respectively.

53. The microfluidic particle sorter as claimed in claim 46, wherein, in each of said two sorter units, said microfluidic channel has two sorting areas and a collection area located between said two sorting areas, said at least one first DLD array and said at least one second DLD array being located in said two sorting areas, respectively.

54. The microfluidic particle sorter as claimed in claim 47, wherein, in each of said two sorter units, said microfluidic channel has two sorting areas and a collection area located between said two sorting areas, said at least one first DLD array and said at least one second DLD array being located in said two sorting areas, respectively.

55. The microfluidic particle sorter as claimed in claim 48, wherein, in each of said two sorter units, said microfluidic channel has two sorting areas and a collection area located between said two sorting areas, said at least one first DLD array and said at least one second DLD array being located in said two sorting areas, respectively.

56. The microfluidic particle sorter as claimed in claim 49, wherein, in each of said two sorter units, said microfluidic channel has two sorting areas and a collection area located between said two sorting areas, said at least one first DLD array and said at least one second DLD array being located in said two sorting areas, respectively.

57. The microfluidic particle sorter as claimed in claim 50, wherein, in each of said two sorter units, said microfluidic channel has two sorting areas and a collection area located between said two sorting areas, said at least one first DLD array and said at least one second DLD array being located in said two sorting areas, respectively.
